(19) United States
(12) Patent Application Publication
(10) Pub. No.: US 2020/0280027 A1
(43) Pub. Date: Sep. 3, 2020

(54) CYLINDRICAL NONAQUEOUS ELECTROLYTE SECONDARY BATTERY

(71) Applicant: SANYO Electric Co., Ltd., Daito-shi, Osaka (JP)

(72) Inventors: Yuji Yamagami, Osaka (JP); Tomohiko Yokoyama, Osaka (JP); Kazutoshi Kohira, Hyogo (JP); Shin Haraguchi, Hyogo (JP)

(73) Assignee: SANYO Electric Co., Ltd., Daito-shi, Osaka (JP)

(21) Appl. No.: 16/645,661

(22) PCT Filed: Sep. 10, 2018
(86) PCT No.: PCT/JP2018/033333

§ 371 Date: Mar. 9, 2020

(30) Foreign Application Priority Data
Sep. 15, 2017 (JP) 2017-178040

(51) Int. Cl. H01M 2/06; H01M 2/02; H01M 2/30; H01M 10/058

(52) U.S. Cl. CPC H01M 2/06; H01M 2/022; H01M 10/058; H01M 2/0277; H01M 2/024; H01M 2/30

(57) ABSTRACT

A battery including an upper insulating plate disposed between a sealing body and an electrode group. The upper insulating plate has a lead hole through which a positive electrode lead penetrates and an opening portion provided at a side opposite to the lead hole with respect to a central axis O of the battery orthogonal to the sealing body. The positive electrode lead has a first curved section adjacent to the lead hole and a second curved section provided at a side opposite to the first curved section with respect to the central axis O. When a distance from the central axis O to a portion of the second curved section farthest from the central axis O is represented by L1, and when a distance from the central axis O to a part of the opening portion nearest to the central axis O is represented by L2, L2>L1 is satisfied.

### TECHNICAL FIELD

The present disclosure relates to a cylindrical nonaqueous electrolyte secondary battery.

### BACKGROUND ART

Heretofore, in order to prevent short circuit caused by contact between a positive electrode lead and an electrode group in a cylindrical secondary battery which uses a positive electrode plate provided with a positive electrode lead, an upper insulating plate having an opening portion has been disposed on the electrode group. The opening portion is used to discharge a high pressure gas generated in the secondary battery through the upper insulating plate or to charge an electrolyte liquid to an electrode group side.

In order to prevent the short circuit described above, Patent Document 1 has disclosed that the diameter of a through-hole provided for liquid charge at a center of an upper insulating plate is formed smaller than the width of a positive electrode lead.

In association with an increase in capacity of a secondary battery, in order to improve discharge performance of gas generated in a secondary battery, Patent Document 2 has disclosed that an opening portion of an upper insulating plate is positively used.

### CITATION LIST

### Patent Literature

Patent Document 1: Japanese Published Unexamined Patent Application No. 3-134955

Patent Document 2: International Publication No. 2014/006883

### SUMMARY OF INVENTION

### Technical Problem

An upper insulating plate not only has a function to secure insulation between an electrode group and a positive electrode lead but also has an important function to control gas emission during internal gas generation in a battery, and to prevent short circuit and to secure emission performance are in a trade-off relationship. In the upper insulating plate, when an opening portion is formed at a side opposite to a lead hole through which the positive electrode lead penetrates with respect to a central axis of the battery, the emission performance can be enhanced. However, when the opening portion is formed, a curved section of the positive electrode lead formed at an upper side than the upper insulating plate is liable to cause short circuit by contact with the electrode group through the opening portion.

The present disclosure aims to provide a cylindrical nonaqueous electrolyte secondary battery which can effectively prevent short circuit between an electrode group and a positive electrode lead while discharge performance of internal gas is secured.

### Solution to Problem

A cylindrical nonaqueous electrolyte secondary battery according to the present disclosure is a cylindrical nonaqueous electrolyte secondary battery which comprises: an exterior package can; a sealing body sealing one end of the exterior package can; an electrode group disposed in the exterior package can; and an insulating plate disposed between the sealing body and the electrode group. In the secondary battery described above, the insulating plate has a lead hole through which a positive electrode lead extending from the electrode group penetrates and an opening portion provided at a side opposite to the lead hole with respect to a central axis of the battery orthogonal to the sealing body, the positive electrode lead has a first curved section adjacent to the lead hole and a second curved section provided at a side opposite to the first curved section with respect to the central axis, and when a distance from the central axis to a portion of the second curved section farthest from the central axis is represented by L1, and a distance from the central axis to a part of the opening portion nearest to the central axis is represented by L2, L2>L1 is satisfied.

### Advantageous Effects of Invention

According to the cylindrical nonaqueous electrolyte secondary battery of the present disclosure, while the discharge performance of internal gas is secured, the short circuit between the electrode group and the positive electrode lead can be effectively prevented.

### BRIEF DESCRIPTION OF DRAWINGS

FIG. 1 is a schematic cross-sectional view of a cylindrical nonaqueous electrolyte secondary battery according to one example of an embodiment.

FIG. 2 is an enlarged view of an A portion of FIG. 1.

FIG. 3(a) is, in the cylindrical nonaqueous electrolyte secondary battery according to the example of the embodiment, a front view showing a state in which a sealing body is welded to a positive electrode lead, and FIG. 3(b) is a side view of FIG. 3(a).

FIG. 4(a) is a plan view of an upper insulating plate according to the example of the embodiment, and FIG. 4(b) is a front view of the upper insulating plate according to the example of the embodiment.

FIG. 5(a) is a plan view of an upper insulating plate according to a comparative example, and FIG. 5(b) is a front view of the upper insulating plate according to the comparative example.

### DESCRIPTION OF EMBODIMENT

Hereinafter, an embodiment according to the present invention will be described in detail with reference to the attached drawings. In the following description, concrete shapes, materials, values, numbers, directions, and the like will be described by way of example in order to facilitate the understanding of the present invention and may be appropriately changed or modified in accordance with a specification of a nonaqueous electrolyte secondary battery. In addition, the term “approximately” to be described below is used, for example, to indicate, besides the case of exactly the same, the case of substantially the same.

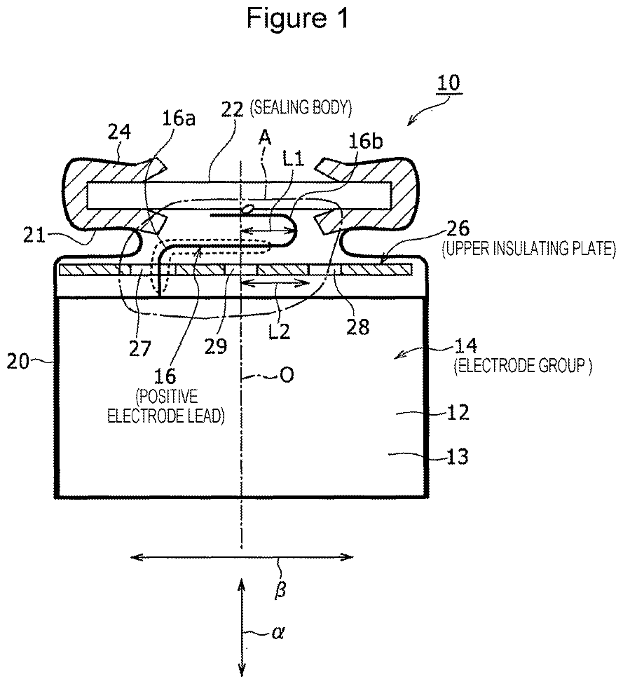

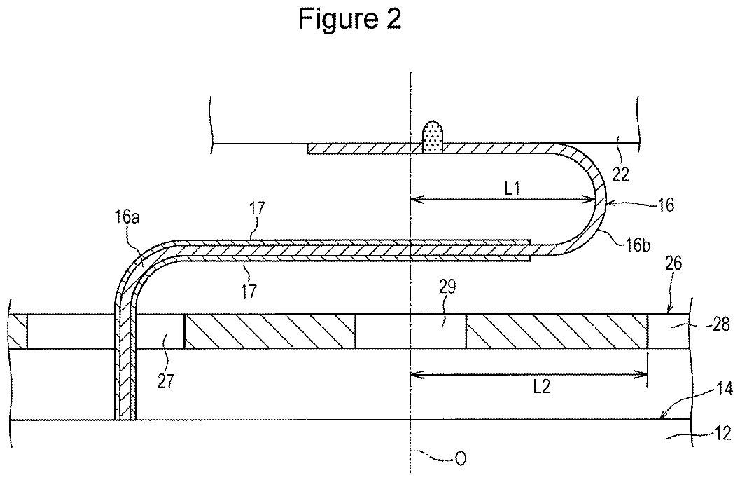

FIG. 1 is a schematic cross-sectional view of a cylindrical nonaqueous electrolyte secondary battery 10 which is one example of the embodiment. FIG. 2 is an enlarged view of an A portion of FIG. 1. As shown in FIGS. 1 and 2, the cylindrical nonaqueous electrolyte secondary battery 10 includes a winding type electrode group 14 and a nonaqueous electrolyte (not shown). The winding type electrode group 14 includes a positive electrode (not shown), a negative electrode 12, and at least one separator (not shown), and the positive electrode and the negative electrode 12 are spirally wound with the separator interposed therebetween. Hereinafter, one side in an axial direction of the electrode group 14 and the other side in the axial direction thereof are called “upper” and “lower”, respectively, in some cases. The nonaqueous electrolyte contains a nonaqueous solvent and an electrolyte salt dissolved therein. The nonaqueous electrolyte is not limited to a liquid electrolyte and may be a solid electrolyte using a gel polymer or the like. Hereinafter, the cylindrical nonaqueous electrolyte secondary battery 10 will be described as the secondary battery 10.

The positive electrode includes a belt-shaped positive electrode collector (not shown). To the positive electrode collector, one end (lower end shown in FIG. 1) of a positive electrode lead 16 is bonded. The positive electrode lead 16 is an electrically conductive member to electrically connect the positive electrode collector to a positive electrode terminal and extends from an upper end of the electrode group 14 to one side (upper side) of the electrode group 14 in an axial direction a. The one end of the positive electrode lead 16 is bonded to a portion of the positive electrode collector located, for example, at an approximately central portion of the electrode group 14 in a radius direction P. In addition, the other end (upper end shown in FIG. 1) of the positive electrode lead 16 is bonded to an approximately center of a lower surface of a sealing body 22.

The negative electrode 12 includes a belt-shaped negative electrode collector 13. To the negative electrode collector 13, a negative electrode lead (not shown) is bonded. The negative electrode lead is an electrically conductive member to electrically connect the negative electrode collector 13 to a negative electrode terminal and extends from a lower end of the electrode group 14 to the other side (lower side) thereof in the axial direction a. For example, the negative electrode lead is provided at a winding start-side end portion of the electrode group 14. A lower end of the negative electrode lead is bonded to a bottom portion of a bottom-closed cylindrical exterior package can 20. In FIG. 1, the negative electrode 12 is exposed as the outermost circumferential surface of the electrode group 14, and the outermost circumferential surface of this negative electrode 12 is in contact with an inner circumferential surface of the exterior package can 20. Accordingly, the negative electrode 12 of the secondary battery 10 is connected to the exterior package can 20 which functions as the negative electrode terminal.

The positive electrode lead 16 and the negative electrode lead are each a belt-shaped electrically conductive member having a thickness larger than that of the collector. The thickness of each lead is, for example, 3 to 30 times the thickness of the collector and is generally 50 to 500 μm. A material forming each lead is not particularly limited. The positive electrode lead 16 is preferably formed of a metal containing aluminum as a primary component. The negative electrode lead is preferably formed of a metal containing nickel or copper as a primary component or a metal containing both nickel and copper. Alternatively, the negative electrode 12 is not exposed as the outermost circumferential surface of the electrode group 14, and a negative electrode lead is bonded to a winding finish-side end portion of the negative electrode collector and is allowed to extend from the lower end of the electrode group 14 to the other side thereof in the axial direction a, so that the two negative electrode leads may be bonded to the bottom portion of the exterior package can 20.

The positive electrode and the negative electrode 12 will be described in more detail. The positive electrode includes the belt-shaped positive electrode collector and at least one positive electrode active material layer formed thereon. For example, on each of two surfaces of the positive electrode collector, the positive electrode active material layer is formed. As the positive electrode collector, foil formed of a metal, such as aluminum, or a film having a surface layer formed of the metal mentioned above may be used. As a preferable positive electrode collector, metal foil containing aluminum or an aluminum alloy as a primary component may be mentioned. The thickness of the positive electrode collector is, for example, 10 to 30 μm.

The positive electrode active material layer is preferably formed on the entire region of each of the two surfaces of the positive electrode collector other than a bare portion to which the positive electrode lead is to be bonded. The positive electrode active material layer preferably contains a positive electrode active material, an electrically conductive agent, and a binder. The positive electrode is formed such that a positive electrode mixture slurry containing the positive electrode active material, the electrically conductive agent, the binder, and a solvent, such as N-methyl-2-pyrrolidone (NMP), is applied on the two surfaces of the positive electrode collector, followed by drying and rolling.

As the positive electrode active material, for example, a lithium transition metal oxide containing at least one transition metal element selected, for example, from Co, Mn, and Ni may be mentioned. Although the lithium transition metal oxide is not particularly limited, a composite oxide represented by a general formula of Li₁₊ₓMO₂ (in the formula, −0.2<x≤0.2 is satisfied, and M represents at least one of Ni, Co, Mn, and Al) is preferable.

As an example of the electrically conductive agent, for example, a carbon material, such as carbon black (CB), acetylene black (AB), Ketjen black, or graphite, may be mentioned. As an example of the binder, for example, there may be mentioned a fluorinated resin, such as a polytetrafluoroethylene (PTFE) or a poly(vinylidene fluoride) (PVdF), a polyacrylonitrile (PAN), a polyimide (PI), an acrylic resin, or a polyolefinic resin. In addition, together with at least one of those resins mentioned above, a carboxymethyl cellulose (CMC) or its salt, a poly(ethylene oxide) (PEO), or the like may be used in combination. Those resins mentioned above may be used alone, or at least two types thereof may be used in combination.

The negative electrode 12 includes the belt-shaped negative electrode collector 13 and at least one negative electrode active material layer formed thereon. For example, on each of two surfaces of the negative electrode collector 13, the negative electrode active material layer is formed. As the negative electrode collector 13, foil formed of a metal, such as copper, or a film having a surface layer formed of the metal mentioned above may be used. The thickness of the negative electrode collector 13 is, for example, 5 to 30 μm.

The negative electrode active material layer is preferably formed on the entire region of each of the two surfaces of the negative electrode collector 13 other than a bare portion to which the negative electrode lead is to be bonded. The negative electrode active material layer preferably contains a negative electrode active material and a binder. The negative electrode 12 is formed such that a negative electrode mixture slurry containing the negative electrode active material, the binder, and water or the like is applied on the two surfaces of the negative electrode collector 13, followed by drying and rolling.

As the negative electrode active material, any material may be used as long as capable of reversibly occluding and releasing lithium ions, and for example, there may be used a carbon material, such as natural graphite or artificial graphite, a metal, such as Si or Sn, forming an alloy with lithium, or an alloy or a composite oxide containing at least one of those mentioned above. As the binder contained in the negative electrode active material layer, for example, a resin similar to that in the case of the positive electrode 11 may be used. When the negative electrode mixture slurry is prepared using an aqueous solvent, for example, a styrene-butadiene rubber (SBR), a CMC or its salt, a polyacrylic acid or its salt, or a poly(vinyl alcohol) may be used. Those resins mentioned above may be used alone, or at least two types thereof may be used in combination.

In the example shown in FIG. 1, by the exterior package can 20 and the sealing body 22, a metal-made battery case receiving the electrode group 14 and the nonaqueous electrolyte is formed. Between the exterior package can 20 and the sealing body 22, a gasket 24 is provided, and hence air tightness in the battery case is secured. The exterior package can 20 has a groove portion 21 formed, for example, by pressing a side surface portion from the outside to support the sealing body 22. The groove portion 21 is preferably formed to have a ring shape along a circumferential direction of the exterior package can 20 and supports the sealing body 22 by an upper surface thereof.

In FIG. 1, the sealing body 22 is schematically shown as a round shape having a rectangular cross-section. For example, the sealing body 22 is composed of a filter, a lower valve, an insulating member, an upper valve, and a cap, which are laminated in this order from an electrode group 14 side. The members forming the sealing body 22 each have, for example, a disc shape or a ring shape, and the members except for the insulating member are electrically connected to each other. The lower valve and the upper valve are connected to each other at central portions thereof, and the insulating member is provided between peripheral portions thereof. When the inside pressure of the battery is increased by abnormal heat generation, for example, the lower valve is fractured, and as a result, the upper valve is expanded to a cap side and is separated from the lower valve, so that the electrical connection between the two valves is blocked. When the inside pressure is further increased, the upper valve is fractured, and gas is discharged through an opening portion formed in the cap.

At an upper side of the electrode group 14, an upper insulating plate 26 is disposed. In FIG. 1, although the upper insulating plate 26 is shown to be apart from the electrode group 14, the upper insulating plate 26 is actually disposed to be in contact with the upper end of the electrode group 14. The positive electrode lead 16 is allowed to extend to a sealing body 22 side through a lead hole 27 which is a through-hole of the upper insulating plate 26 and is welded to a lower surface of the sealing body 22. In the secondary battery 10, a top plate of the sealing body 22 or the cap located at an upper end is used as the positive electrode terminal.

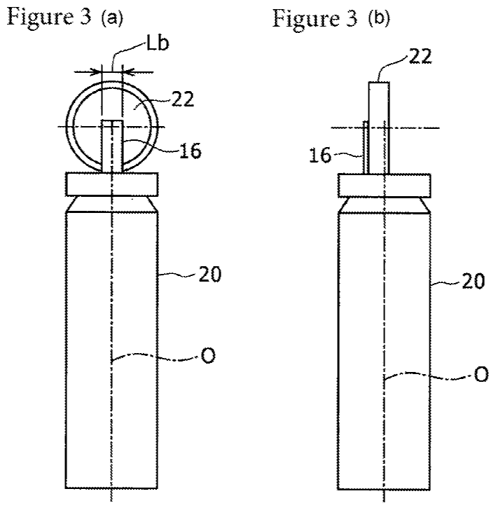

FIG. 3(a) is a front view showing, in the secondary battery 10, a state in which the sealing body 22 is welded to the positive electrode lead 16, and FIG. 3(b) is a side view of FIG. 3(a). In FIG. 3, as is the case shown in FIG. 1, the sealing body 22 is also schematically shown to have a disc shape. As shown in FIG. 3, when the positive electrode lead 16 is welded to the sealing body 22, the sealing body is disposed to be overlapped with the positive electrode lead 16 extending from the electrode group 14. In addition, by laser welding or the like, the positive electrode lead 16 is welded to the sealing body 22. In the positive electrode lead 16, as shown in FIG. 2, an insulating tape 17 is adhered to a portion surrounded by a dotted line in FIG. 1.

After the positive electrode lead 16 is welded to the sealing body 22 as described above, the sealing body 22 is fitted to an upper portion of the exterior package can 20. In this step, the positive electrode lead 16 is bent at a position adjacent to the lead hole 27 to form a first curved section 16a. Furthermore, the positive electrode lead 16 is folded back at a position opposite to the first curved section 16a with respect to a central axis O of the secondary battery 10 orthogonal to the sealing body 22 to form a second curved section 16b. As shown in FIGS. 1 and 2, the insulating tape 17 is adhered to the positive electrode lead 16. In order not to disturb the welding between the sealing body 22 and the positive electrode lead 16, the insulating tape 17 is preferably adhered to a region of the positive electrode lead 16 from the electrode group 14 side toward the sealing body 22 side so as not to extend past an inflection point of the second curved section 16b. In addition, the insulating tape may be adhered not only to a portion of the positive electrode lead 16 extending from the electrode group 14 but also to a portion of the positive electrode lead 16 disposed in the electrode group 14 or may be adhered only to a surface of the positive electrode lead 16 facing the upper insulating plate 26. In addition, the insulating tape may be adhered so as to be spirally wound around the portion of the positive electrode lead 16 surrounded by the dotted line shown in FIG. 1.

The secondary battery 10 may be compressively deformed, for example, by a crushing test in some cases. In this case, when an opening portion 28 is formed in the upper insulating plate 26 at a second curved section 16b side as described later, the second curved section 16b comes in contact with the electrode group 14 through the opening portion 28, so that short circuit may probably occur in some cases. In this embodiment, in order to effectively prevent this short circuit, as described later, the position of the opening portion 28 of the upper insulating plate 26 is appropriately restricted.

In addition, in the exterior package can 20, between the lower end of the electrode group 14 and the bottom portion of the exterior package can 20, a lower insulating plate (not shown) is disposed. In a center portion of the lower insulating plate, a through-hole is formed. The negative electrode lead (not shown) bonded to the one end of the negative electrode collector 13 is allowed to extend to a lower side of the lower insulating plate through the through-hole thereof or along an outer circumferential side of the lower insulating plate and is then bonded to the bottom portion of the exterior package can 20 by welding.

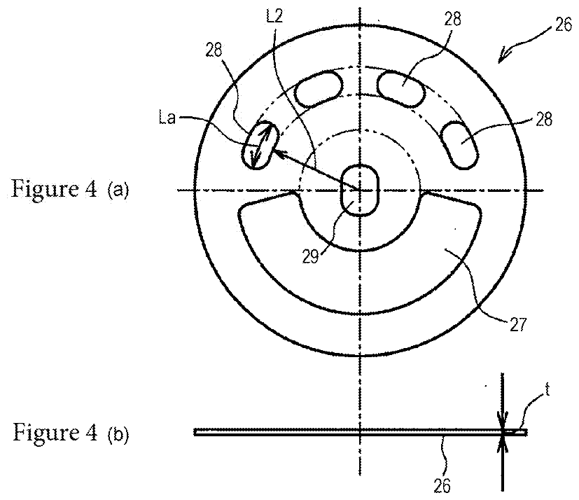

The upper insulating plate 26 will be described in detail with reference to FIG. 4. FIG. 4(a) is a plan view of the upper insulating plate 26, and FIG. 4(b) is a front view thereof. The upper insulating plate 26 has a round shape with a small thickness t. The upper insulating plate 26 is formed, for example, from an insulating material, such as a glass cloth phenol containing a phenol resin and a glass fiber base material impregnated therewith. In one half portion (lower half portion in FIG. 4(a)) of the upper insulating plate 26, an arc-shaped lead hole 27 having an approximately half circle is formed. On the other hand, in the other half portion (upper half portion in FIG. 4(a)) of the upper insulating plate 26, along an intermediate portion in a radius direction, the opening portions 28 each having an oval shape are formed at positions apart from each other in a circumferential direction. A maximum length La of the opening portion 28, which is the width thereof in the circumferential direction, along the longitudinal direction of the opening portion 28 is preferably set to be smaller than a width Lb (FIG. 3(a)) of the positive electrode lead 16 (La<Lb).

The distances from the center of the upper insulating plate 26 to the opening portions 28 are the same. In addition, in the center of the upper insulating plate 26, a central hole 29 having an approximately oval shape is formed. The opening portions 28, the central hole 29, and the lead hole 27 are each preferably formed larger in order to improve the emission performance when gas is generated in the secondary battery 10.

In addition, as shown in FIG. 1, in the state in which the upper insulating plate 26 is disposed in the secondary battery 10, in the upper insulating plate 26, the four opening portions 28 are formed at positions opposite to the lead hole 27 with respect to the central axis O of the secondary battery. When the positive electrode lead 16 and the upper insulating plate 26 are viewed from the sealing body 22 side (upper side in FIG. 1), since the central hole 29 is formed so as to be overlapped with a hollow portion of the electrode group 14, the probability of short circuit caused by contact between the positive electrode lead 16 and the electrode group 14 through the central hole 29 is low. However, when the positive electrode lead 16 and the upper insulating plate 26 are viewed from the sealing body 22 side, the central hole 29 is preferably formed at a position so as to be overlapped with the portion at which the insulating tape 17b is adhered to the positive electrode lead 16. Furthermore, when the distance from the central axis O of the secondary battery 10 to the second curved section 16b (distance from the central axis O to a portion of the second curved section 16b farthest therefrom) is represented by L1, and when the distance from the central axis O of the secondary battery 10 to the opening portion 28 (distance from the central axis O to a part of the opening portion 28 nearest thereto) is represented by L2, L1 and L2 are restricted so as to satisfy L2>L1. As long as the restriction described above is satisfied, the position and the shape of the opening portion 28 are not limited to those of this embodiment.

Furthermore, in the upper insulating plate 26, although opening ratios of all the openings including the opening portion 28, the central hole 29, and the lead hole 27 are not particularly limited, the ratios are each preferably 20% or more. Although the upper limit of the opening ratio may be appropriately determined in accordance with the strength of the upper insulating plate 26, for example, the upper limit may be set to 60% or less.

According to the secondary battery 10 described above, when the distance from the central axis O of the secondary battery 10 to the second curved section 16b of the positive electrode lead 16 is set to be L1, and when the distance from the central axis O of the secondary battery 10 to the opening portion 28 is set to be L2, the distances L1 and L2 are restricted so as to satisfy L2>L1. Hence, while the discharge performance of internal gas is secured, the short circuit between the electrode group 14 and the positive electrode lead 16 can be effectively prevented.

In addition, in the upper insulating plate 26, when the maximum length La (FIG. 4) of each opening portion 28 is set to be smaller than the width Lb (FIG. 3(a)) of the positive electrode lead 16, even if the curved section of the positive electrode lead 16 is deformed to the electrode group side by a crushing test, the short circuit between the electrode group and the positive electrode lead 16 can be sufficiently suppressed.

Furthermore, the opening ratio of the upper insulating plate 26 is 20% or more. Accordingly, the emission performance of internal gas can be further improved.

### Experimental Example

The inventor of the present disclosure formed secondary batteries of an example and a comparative example as described below and then performed a crushing test.

### Example

[Formation of Positive Electrode]

As a positive electrode active material, an aluminum-containing lithium nickel cobalt oxide represented by LiNi_{0.88}Co_{0.09}Al_{0.03}O₂ was used. Subsequently, 100 parts by weight of LiNi_{0.88}Co_{0.09}Al_{0.03}O₂, 1.0 part by weight of acetylene black, and 0.9 parts by weight of a poly(vinylidene fluoride) (PVdF) (binder) were mixed in a solvent of N-methyl-2-pyrrolidone (NMP), so that a positive electrode mixture slurry was obtained. This positive electrode mixture slurry in the form of paste was uniformly applied on two surfaces of a long positive electrode collector formed from aluminum foil having a thickness of 15 μm. Next, in a heated dryer, after the positive electrode collector on which the coating films were formed was heat-treated at a temperature of 100° C. to 150° C. to remove NMP, rolling was performed using a roll press machine to form a positive electrode active material layer, and furthermore, after the rolling was performed, a positive electrode was brought into contact with at least one roller heated to 200° C. for 5 seconds to perform a heat treatment. In addition, the positive electrode collector on which positive electrode active material layers were formed was cut into a predetermined electrode size to form the positive electrode, and next, an aluminum-made positive electrode lead 16 was fitted on the positive electrode collector. The thickness, the width, and the length of the positive electrode thus formed were 0.144 mm, 62.6 mm, and 861 mm, respectively. In addition, the width, the thickness, and the length of the positive electrode lead 16 were 3.5 mm, 0.15 mm, and 76 mm, respectively.

[Formation of Negative Electrode]

As a negative electrode active material, there was used a mixture obtained by mixing 94 parts by weight of a graphite powder and 6 parts by weight of mother particles containing a lithium silicate phase represented by Li₂Si₂O₅ and silicon particles dispersed therein. Subsequently, the mixture described above, 1 part by weight of a carboxymethyl cellulose (CMC) as a thickening agent, and 1 part by weight of a dispersion of a styrene-butadiene rubber as a binder were dispersed in water, so that a negative electrode mixture slurry was prepared. This negative electrode mixture slurry was applied on two surfaces of a negative electrode collector formed from copper foil having a thickness of 8 m to form negative electrode coating portions. Next, after coating films were dried in a heated dryer, the thickness of a negative electrode active material layer was adjusted by compression using compression rollers so that the thickness of a negative electrode was 0.160 mm. In addition, the negative electrode collector on which the negative electrode active material layers were formed was cut into a predetermined electrode size to form a negative electrode 12, and subsequently, a nickel-copper-nickel-made negative electrode lead was fitted on the negative electrode collector. The negative electrode thus formed had a width of 64.2 mm and a length of 959 mm.

[Formation of Battery Electrode Group]

An electrode group 14 was formed by spirally winding the positive electrode and the negative electrode 12 with polyethylene-made separators interposed therebetween.

[Preparation of Nonaqueous Electrolyte Liquid]

After 4 parts by weight of vinylene carbonate (VC) was added to 100 parts by weight of a mixed solvent containing ethylene carbonate (EC), fluoroethylene carbonate (FEC), and dimethyl methyl carbonate (DMC) (volume ratio: EC:FEC:DMC=1:1:3), LiPF₆ was dissolved in this mixed solvent to obtain a concentration of 1.5 mole/L, so that a nonaqueous electrolyte liquid was prepared. To 100 parts by weight of the nonaqueous electrolyte liquid thus prepared, a predetermined amount of a boric acid ester compound was added to form a nonaqueous electrolyte liquid for a secondary battery.

[Formation of Upper Insulating Plate]

As an upper insulating plate 26, a round-shaped plate member formed from a glass cloth phenol having a thickness t of 0.3 mm was used, a lead hole 27 through which a positive electrode lead 16 was to penetrate, a central hole 29, and four opening portions 28 were formed. The four opening portions 28 were formed at four positions located at a side opposite to the lead hole 27 with respect to the center of the upper insulating plate 26 and were separated from each other in a circumferential direction of the upper insulating plate 26.

[Formation of Secondary Battery]

After the upper insulating plate 26 and a lower insulating plate were disposed at an upper side and a lower side of the electrode group 14, respectively, the electrode group 14 was received in an exterior package can 20. The positive electrode lead 16 extended from the electrode group 14 through the lead hole 27 of the upper insulating plate 26. The negative electrode lead was welded to the exterior package can 20 of a battery case, and the positive electrode lead 16 was welded to a sealing body including an inner pressure sensitive safety valve. Subsequently, the nonaqueous electrolyte liquid was charged in the battery case by a reduced pressure method. Finally, a sealing body 22 was caulked at an upper opening end portion of the exterior package can 20 with a gasket 24 interposed therebetween, so that a secondary battery 10 was formed. The capacity of the secondary battery 10 was 4,600 mAH. As shown in FIG. 1, the center of the upper insulating plate 26 was located at the central axis O of the secondary battery 10, and after the first curved section 16a and the second curved section 16b of the positive electrode lead 16 were formed, the positive electrode lead 16 was received in the battery case. As described above, in the state in which the positive electrode lead 16 was received in the battery case, the distance L1 from the central axis O of the secondary battery 10 to the second curved section 16b was 5.3 mm, and the distance L2 from the central axis O of the secondary battery 10 to the opening portion 28 was 5.9 mm.

### Comparative Example

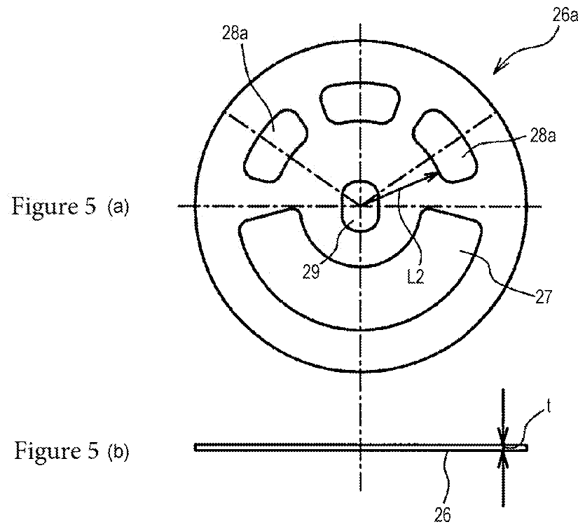

FIG. 5(a) is a plan view of an upper insulating plate 26a of a comparative example, and FIG. 5(b) is a front view of the upper insulating plate 26a of the comparative example. As shown in FIG. 5, by using a round-shaped plate member formed from a glass cloth phenol having a thickness t of 0.3 mm, a lead hole 27a through which a positive electrode lead was to penetrate, a central hole 29, and three opening portions 28a were formed, so that the upper insulating plate 26a according to the comparative example was formed. The three opening portions 28a were formed at three positions located at a side opposite to the lead hole 27a with respect to the center of the upper insulating plate and were separated from each other in a circumferential direction of the upper insulating plate 26a. Except for that the upper insulating plate 26a was used, the distance L1 from the central axis of the secondary battery to the second curved section 16b of the positive electrode lead 16 was set to 5.3 mm, and the distance L2 from the central axis of the secondary battery to the opening portion 28a was set to 5.2 mm, a secondary battery according to the comparative example was formed in a manner similar to that of the example.

[Crushing Test]

By using the example and the comparative example, the influence of the distance L1 from the central axis of the secondary battery to the second curved section and the distance L2 from the central axis of the secondary battery to each of the opening portions 28 and 28a on the generation of short circuit caused by contact between the positive electrode lead 16 and the electrode group was investigated. For this investigation, a crushing test was performed in accordance with the following procedure from (1) to (3).

(1) In each of the example and the comparative example, a partially charged secondary battery was used.
(2) The secondary battery was disposed between two flat plates, and a load was to be applied from the side of the secondary battery by a crushing device. After reaching a target applying force, the load thus applied was maintained for one minute and was then released. The crushing test was performed at target applying forces of 13 kN and 20 kN.
(3) In this test, when the temperature of the secondary battery was increased to 40° C. or more, it was judged that heat generation occurred by the short circuit between the positive electrode lead 16 and the electrode group 14. The test results are shown in Table 1.

TABLE 1

| | TARGET APPLYING | TARGET APPLYING |
|---|---|---|
| | FORCE | FORCE |
| | 13 kN | 20 kN |
| COMPARATIVE | 0/5 | 1/5 |
| EXAMPLE | | |
| EXAMPLE | 0/20 | 0/20 |

In Table 1, in the comparative example and the example, the rates of heat generation by the contact between the second curved section 16b of the positive electrode lead 16 and the electrode group 14 are shown at target applying forces of 13 kN and 20 kN. For example, in Table 1, “0/5” indicates that among five crushing tests, the number of test results indicating the heat generation was zero.

In the example, in the tests performed at the two target applying forces, the heat generation caused by the short circuit between the second curved section 16b of the positive electrode lead 16 and the negative electrode of the electrode group 14 through the opening portion 28 of the upper insulating plate 26 was not observed. Accordingly, as shown in Table 1, in the example, at the both target applying forces, no heat generation was observed among 20 crushing tests.

On the other hand, in the comparative example, by the test at a target applying force of 13 kN, no heat generation was observed. However, in the test at a target applying force of 20 kN, by the short circuit between the second curved section 16b of the positive electrode lead 16 and the negative electrode of the electrode group 14, at a fifth test, the temperature of the secondary battery was increased close to 120° C., and hence, the heat generation was observed. In the comparative example, since the heat generation was observed at the fifth test, a sixth test or more was not performed.

From the test results described above, since the opening portions 28 were formed in the upper insulating plate 26 at an outer circumferential side than the second curved section 16b of the positive electrode lead 16 as shown in the example, an effect of preventing the short circuit caused by the positive electrode lead 16 which intrudes into the electrode group 14 through the opening portion 28 could be confirmed.

In addition, although the case in which the central hole 29 is formed at the center of the upper insulating plate 26 has thus been described, the structure of the present disclosure may also be applied to the structure having no central hole.

### REFERENCE SIGNS LIST

10 cylindrical nonaqueous electrolyte secondary battery (secondary battery), 12 negative electrode, 14 electrode group, 16 positive electrode lead, 16a first curved section, 16b second curved section, 17 insulating tape, 20 exterior package can, 21 groove portion, 22 sealing body, 24 gasket, 26, 26a upper insulating plate, 27 lead hole, 28, 28a opening portion, 29 central hole

1. A cylindrical nonaqueous electrolyte secondary battery comprising: an exterior package can; a sealing body sealing one end of the exterior package can; an electrode group disposed in the exterior package can; and an insulating plate disposed between the sealing body and the electrode group,
wherein the insulating plate has a lead hole through which a positive electrode lead extending from the electrode group penetrates and an opening portion provided at a side opposite to the lead hole with respect to a central axis of the battery orthogonal to the sealing body,
the positive electrode lead has a first curved section adjacent to the lead hole and a second curved section provided at a side opposite to the first curved section with respect to the central axis, and
when a distance from the central axis to a portion of the second curved section farthest from the central axis is represented by L1, and a distance from the central axis to a part of the opening portion nearest to the central axis is represented by L2, L2>L1 is satisfied.

2. The cylindrical nonaqueous electrolyte secondary battery according to claim 1,
further comprising an insulating tape which is adhered to the positive electrode lead in a range from the electrode group to an inflection point of the second curved section in a direction toward the sealing body.

3. The cylindrical nonaqueous electrolyte secondary battery according to claim 1,
wherein the maximum length of the opening portion in the insulating plate is smaller than the width of the positive electrode lead.

4. The cylindrical nonaqueous electrolyte secondary battery according to claim 1,
wherein the insulating plate has an opening ratio of 20% or more.
